(19) United States
(12) Patent Application Publication
(10) Pub. No.: US 2005/0009956 A1
(43) Pub. Date: Jan. 13, 2005

(54) Silicone rubber coating composition

(76) Inventor: Tsuneo Kimura, Gunma-ken (JP)

Correspondence Address: BIRCH STEWART KOLASCH & BIRCH, PO BOX 747, FALLS CHURCH, VA, 22040-0747, US

(21) Appl. No.: 10/885,677

(22) Filed: Jul. 8, 2004

(30) Foreign Application Priority Data
Jul. 9, 2003 (JP) 2003-194280

(51) Int. Cl. C08K 9/10; C08K 3/10

(52) U.S. Cl. 523/212; 524/437; 523/210

(57) ABSTRACT

A silicone rubber coating composition comprising (A) an organopolysiloxane, (B) an organosilicon compound having at least three hydrolyzable groups or a partial hydrolyzate thereof, and (C) aluminum hydroxide surface treated with a silane, siloxane or silazane is coated onto the surface of an insulator body to form a high-voltage electric insulator film which maintains the stabilized electrical properties of silicone rubber over a long term even in the ambient environment.

### TECHNICAL FIELD

This invention relates to a silicone rubber coating composition which cures at room temperature into a silicone rubber serving as a high-voltage electrical insulator.

### BACKGROUND ART

In general, high-voltage electrical insulating materials for use as insulators and bushings for power transmission lines are of porcelain (ceramics) or glass. Since these insulators are heavy and liable to breakage due to a lack of impact resistance, they require careful handling and impose a burden to workers. In a polluted environment as in seaside areas and industrial areas, there is a tendency that dust, salts and mist attach to the surface of high-voltage electrical insulators, causing leakage currents and dry band discharge leading to flashover failure.

In order to eliminate the drawbacks of porcelain and glass insulators, a number of proposals have been made. It is well known in the art that current leakage is effectively avoided by coating the insulator surface with silicone-base grease. Since the grease surface is contaminated with the passage of time, it is necessary to clean the grease surface or coat the grease again at intervals of 2 years or so.

It is proposed to substitute a curable silicone rubber for the silicone grease. For example, U.S. Pat. No. 3,511,698 discloses a weathering resistant high-voltage electrical insulator comprising a member of a curable resin and a platinum catalyst-containing organopolysiloxane elastomer coating agent. JP-A 7-57574 describes that the blending of a methylalkylsiloxane fluid in silicone rubber is effective for providing contact angle recovery with time and preventing flashover failure. However, they are organopolysiloxane compositions of the addition curing type, which are susceptible to cure hindrance or cure defects by environmental factors. Frequent failures can occur when these compositions are applied in an ordinary environment whether it is indoor or outdoor.

In contrast, JP-A 59-198604 corresponding to U.S. Pat. No. 4,476,155 proposes a one-part room temperature curable organopolysiloxane composition of the condensation oxime-removal cure type having aluminum hydroxide with a mean particle size of less than 5 μm incorporated therein. The composition is applied to the outer surface of an electrical insulator of glass or porcelain so that the electrical insulator may maintain its high insulating properties even in the presence of moisture, polluted air, ultraviolet radiation and other outdoor stresses. Also, JP-A 7-133431 discloses a one-part room temperature curable organopolysiloxane composition of the condensation cure type comprising aluminum hydroxide and an alkoxysilane having fluorinated organic groups. However, the former uses aluminum hydroxide of a very small particle size and requires an intense dispersion step like heat treatment during the mixing with dimethylsiloxane, in order to provide a necessary level of applicability for coating. Even when the intense dispersion step is carried out, the finished composition has a high viscosity, preventing the composition to develop the flow and ease of working necessary for coating. The latter is economically disadvantageous because the alkoxysilanes having fluorinated organic groups are expensive. In addition, the silicone rubber materials used in these prior art techniques are not yet fully satisfactory in high-voltage electrical properties. They must be loaded with large amounts of aluminum hydroxide in order to improve the electrical insulation. This raises a new problem that the electrical properties degrade in a humid environment because aluminum hydroxide is hygroscopic by nature.

JP-A 54-90349 discloses a room temperature curable organopolysiloxane composition having incorporated therein aluminum hydroxide treated with stearic acid or metaphosphoric acid, the composition featuring self-extinguishing properties. However, the composition is not satisfactory in tracking resistance.

JP-A 2003-12879 discloses a curable saturated hydrocarbon composition having incorporated therein aluminum hydroxide surface treated with a silane coupling agent. This composition has inferior tracking resistance to the silicone compositions and when used as the coating agent, is ineffective to work or process.

### SUMMARY OF THE INVENTION

An object of the invention is to provide a silicone rubber coating composition for use as a high-voltage electric insulator, comprising a silicone rubber loaded with aluminum hydroxide, which composition maintains electrical properties of silicone rubber over a long period of time despite the aluminum oxide loading, develops an effective level of flow and workability to form a coating, and is economically advantageous.

The inventor has found that when silane, siloxane or silazane-treated aluminum hydroxide is incorporated in a silicone rubber composition of the condensation reaction type, the cured silicone rubber composition has long-lasting stable electrical properties so that it is suited for use as a high-voltage electric insulator.

According to the invention, there is provided a silicone rubber coating composition for use as a high-voltage electric insulator, comprising

(A) 100 parts by weight of an organopolysiloxane having the general formula (1):
HO(SiR₂O)ₙH (1)
wherein R is each independently a substituted or unsubstituted monovalent hydrocarbon group having 1 to 10 carbon atoms, and n is an integer of at least 10, and/or an organopolysiloxane having the general formula (2): 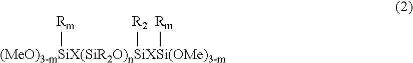
wherein R and n are as defined above, Me is methyl, X is an oxygen atom or an alkylene group having 2 to 5 carbon atoms, and m is each independently 0 or 1,

(B) 0.1 to 50 parts by weight of an organosilicon compound having at least three hydrolyzable groups each attached to a silicon atom in a molecule or a partial hydrolyzate thereof, and

(C) 20 to 400 parts by weight of aluminum hydroxide which has been surface treated with a silane, siloxane or silazane.

### DESCRIPTION OF THE PREFERRED EMBODIMENT

Component A

In the silicone rubber coating composition for use as a high-voltage electric insulator according to the invention, component (A) is at least one organopolysiloxane selected from among organopolysiloxanes having the general formulae (1) and (2).
HO(SiR₂O)ₙH (1)

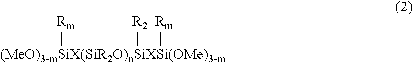

In formulae (1) and (2), R is a substituted or unsubstituted monovalent hydrocarbon group having 1 to 10 carbon atoms, for example, alkyl groups such as methyl, ethyl and propyl, cycloalkyl groups such as cyclohexyl, alkenyl groups such as vinyl and allyl, aryl groups such as phenyl and tolyl, and substituted forms of the foregoing groups in which some hydrogen atoms are substituted with halogen atoms or the like, such as 3,3,3-trifluoropropyl. Of these, methyl, vinyl, phenyl and 3,3,3-trifluoropropyl are preferred, with methyl being most preferred. A plurality of R groups in formula (1) or (2) may be the same or different. The subscript n is an integer of at least 10, and especially such an integer that the diorganopolysiloxane may have a viscosity at 25° C. of 25 to 500,000 mPa.s, especially 500 to 100,000 mPa·s. In formula (2), Me is methyl, X is an oxygen atom or an alkylene group having 2 to 5 carbon atoms, such as ethylene, propylene or butylene. Of these, oxygen and ethylene are preferred. The subscript m is each independently 0 or 1.

Component B

Component (B) is an organosilicon compound having at least three hydrolyzable groups each attached to a silicon atom in a molecule or a partial hydrolyzate thereof. Suitable hydrolyzable groups include ketoxime groups, alkoxy groups, acetoxy groups and isopropenoxy groups. Illustrative examples of the organosilicon compound (B) include ketoximesilanes such as tetrakis(methylethylketoxime)silane, methyltris(dimethylketoxime)silane, methyltris(methylethylketoxime)silane, ethyltris(methylethylketoxime)silane, methyltris(methylisobutylketoxime)silane, and vinyltris(methylethylketoxime)silane; alkoxysilanes such as methyltrimethoxysilane, vinyltrimethoxysilane, phenyltrimethoxysilane, and vinyltriethoxysilane; acetoxysilanes such as methyltriacetoxysilane and vinyltriacetoxysilane; isopropenoxysilanes such as methyltriisopropenoxysilane, vinyltriisopropenoxysilane, and phenyltriisopropenoxysilane, and partial hydrolytic condensates of the foregoing silanes.

Component (B) is used in an amount of 0.1 to 50 parts by weight, preferably 5 to 30 parts by weight per 100 parts by weight of component (A). Less than 0.1 pbw of component (B) fails to achieve full crosslinkage and to formulate a composition having desired rubber elasticity whereas more than 50 pbw of component (B) tends to form a cured part having poor mechanical properties.

Component C

Component (C) is aluminum hydroxide which has been surface treated with a silane, siloxane or silazane. The surface-treated aluminum hydroxide (C) is effective for improving the electrical insulating properties, typically arc resistance and tracking resistance, of silicone rubber. In addition, the surface treatment of aluminum hydroxide has the effect of preventing the electrical insulating properties from degrading under wet conditions. In this sense, component (C) is essential to the inventive composition. Aluminum hydroxide used herein is represented by the formula: Al₂O₃.3H₂O and in particulate form preferably having a mean particle size of 6 to 30 μm, especially 8 to 15 μm and a specific surface area of 1.0 to 10 m²/g as measured by the BET method. With a mean particle size of less than 6 μm, the composition may have too high a viscosity or thixotropy, making it difficult to apply as a coating. Aluminum hydroxide with a mean particle size of more than 30 μm can reduce the elongation and tensile strength of the cured composition.

The surface treated aluminum hydroxide has carbon deposited on surfaces as a result of treatment with the silane, siloxane or silazane. The amount of carbon deposited on aluminum hydroxide is an amount necessary to render aluminum hydroxide particles hydrophobic, specifically 0.01 to 2% by weight, preferably 0.02 to 1% by weight based on the aluminum hydroxide. A carbon deposition amount of less than 0.01% by weight may allow the aluminum hydroxide to absorb more moisture (water), with electrical properties being degraded by moisture (water) absorption. A carbon deposition amount of more than 2% by weight may be difficult to achieve by ordinary surface treatment without adding to the cost.

Suitable silanes, siloxanes and silazanes which can be used for surface treatment include alkylsilanes, alkenyl group-containing silanes, alkylsilazanes, and alkenyl group-containing silazanes and partial hydrolyzates thereof. Specific examples include silazanes such as hexamethyldisilazane; alkenyl group-containing silazanes such as divinyltetramethyldisilazane; alkoxysilanes such as methyltrimethoxysilane, ethyltriethoxysilane, dimethyldimethoxysilane, diethyldimethoxysilane, and trimethylmethoxysilane; chlorosilanes such as methyltrichlorosilane and ethyltrichlorosilane; and vinyl group-containing silanes such as vinyltrimethoxysilane, vinyltriethoxysilane and vinyltrichlorosilane.

The surface treated aluminum hydroxide is obtained by well-known surface treating methods, for example, by mixing untreated aluminum hydroxide with the above-mentioned surface treating agents (including silanes, siloxanes and silazanes). In particular, aluminum hydroxide having a specific amount of carbon deposited thereon is prepared, for example, by adding an amount of the treating agent to untreated aluminum hydroxide, fully agitating and mixing at room temperature, and further agitating while heating, for example, at 100° C. for about 2 hours. Of the above-mentioned surface treating agents, alkyl-containing agents including alkylalkoxysilanes (especially, ethylalkoxysilanes) and partial hydrolyzates thereof and alkylsilazanes are preferred. In this case, alkyl groups are present on the surface of surface treated aluminum hydroxide. The alkyl groups may be either firmly bound to aluminum hydroxide as a result of reaction of the treating agent with aluminum hydroxide or simply present by way of physical adsorption. Further, the alkyl groups may be averagely present on the surface of aluminum hydroxide. It is also acceptable that the alkyl groups be eventually present in a necessary amount as a result of mixing of treated aluminum hydroxide with untreated one or fairly treated one.

The surface treated aluminum hydroxide (C) is compounded in an amount of 30 to 400 parts by weight, preferably 50 to 350 parts by weight, more preferably 80 to 300 parts by weight per 100 parts by weight of component (A). Less than 30 pbw of aluminum hydroxide fails to achieve satisfactory electrical properties such as tracking resistance. More than 400 pbw of aluminum hydroxide is difficult to compound and the composition becomes difficult to work and after curing, becomes hard and brittle.

Component D

Component (D) is a solvent which is optionally used when the inventive composition is applied to the surface of an insulator. The solvent may be added to the composition for the dilution purpose prior to use. Alternatively, the solvent may be previously added during preparation of the composition. There may be used any of well-known solvents which are customarily used in compositions of the room temperature condensation cure type, for example, aliphatic hydrocarbons such as pentane, hexane, heptane, gasoline, and isoparaffin, aromatic hydrocarbons such as toluene and xylene, carboxylic esters such as ethyl acetate and butyl acetate, ketones such as acetone, methyl ethyl ketone and methyl isobutyl ketone, and ethers such as tetrahydrofuran and dibutyl ether. In view of working factors including odor, toxicity and efficiency, aliphatic hydrocarbons and aromatic hydrocarbons are advantageously used.

The solvent is used in an amount to facilitate coating operation, preferably in such an amount that the total amount of components other than the solvent is 50 to 98% by weight, more preferably 70 to 95% by weight. If the amount of the solvent is too much, a coating of the composition may become too thin to provide tracking resistance. Operation becomes inefficient when such a dilute composition is repeatedly applied until a necessary thickness is reached.

Other components

Preferably, the inventive composition further contains adhesion improvers and (condensation) catalysts. Suitable adhesion improvers include γ-aminopropyltriethoxysilane and γ-glycidoxypropyltriethoxysilane and are typically used in an amount of 0.1 to 20 parts by weight, preferably 0.5 to 10 parts by weight per 100 parts by weight of component (A). Suitable (condensation) catalysts include organic tin esters, organic tin chelates, alkoxytitanium compounds, titanium chelates, and guanidyl group-containing silicon compounds and are typically used in an amount of 0.01 to 10 parts by weight, preferably 0.05 to 5 parts by weight per 100 parts by weight of component (A).

In addition to the foregoing components, well-known fillers and additives may be added to the inventive composition as long as they have no negative impact on the cure at room temperature of the composition and the tracking resistance and electrical properties of the cured composition. Suitable fillers include reinforcing fillers such as ground silica, fumed silica, precipitated silica, wet silica, titanium dioxide, aluminum oxide, carbon powder, talc and bentonite, and basic fillers such as calcium carbonate, zinc carbonate, basic zinc carbonate, zinc oxide, and magnesium oxide. Suitable additives include thixotropic agents such as polyethers, colorants such as pigments and dyes, heat resistance improvers such as red iron oxide and cerium oxide, freeze resistance improvers, rust preventives, and oil resistance improvers such as potassium methacrylate. If desired, mildew-proof agents and antibacterial agents are added.

### EXAMPLE

Examples of the invention are given below by way of illustration and not by way of limitation. All parts and percents are by weight. Mw is a weight average molecular weight and Mn is a number average molecular weight.

### Example 1

To 100 parts of a hydroxyl end-capped polydimethylsiloxane having a viscosity of 20,000 mPa·s at 23° C. was added 120 parts of aluminum hydroxide which had been surface treated with ethyltrimethoxysilane to a carbon deposition amount of 0.32% and had a mean particle size of 10 μm. They were mixed on a mixer, to which were added 15 parts of methyltributanoximesilane, 0.1 part of dioctyltin dilaurate and 1 part of γ-aminopropyltriethoxysilane. The ingredients were thoroughly mixed under reduced pressure, further combined with 50 parts of gasoline, and thoroughly mixed in a dry nitrogen atmosphere, yielding Composition 1.

### Example 2

To 100 parts of a trimethoxy end-capped polydimethylsiloxane having a viscosity of 20,000 mPa·s at 23° C. was added 120 parts of aluminum hydroxide which had been surface treated with divinyltetramethyldisilazane and hexamethyldisilazane to a carbon deposition amount of 0.10% and had a mean particle size of 10 μm. They were mixed on a mixer, to which were added 10 parts of vinyltrimethoxysilane, 3 parts of diisopropoxytitanium bisacetylacetonate and 1 part of γ-glycidoxypropyltriethoxysilane. The ingredients were thoroughly mixed under reduced pressure, further combined with 50 parts of gasoline, and thoroughly mixed in a dry nitrogen atmosphere, yielding Composition 2.

### Comparative Example 1

Composition 3 was prepared by the same procedure as in Example 1 except that 120 parts of untreated aluminum hydroxide having a mean particle size of 10 μm was used instead of 120 parts of the ethyltrimethoxysilane-treated aluminum hydroxide having a mean particle size of 10 μm.

### Comparative Example 2

Composition 4 was prepared by the same procedure as in Example 1 except that 120 parts of untreated aluminum hydroxide having a mean particle size of 1 μm was used instead of 120 parts of the ethyltrimethoxysilane-treated aluminum hydroxide having a mean particle size of 10 μm.

### Comparative Example 3

Composition 5 was prepared by the same procedure as in Example 1 except that 120 parts of stearic acid-treated aluminum hydroxide having a mean particle size of 10 μm was used instead of 120 parts of the ethyltrimethoxysilane-treated aluminum hydroxide having a mean particle size of 10 μm.

### Comparative Example 4

Composition 6 was prepared by the same procedure as in Example 1 except that 100 parts of a saturated hydrocarbon polymer having the general formula (3): 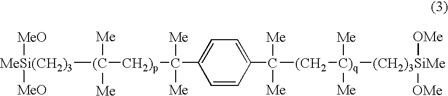
wherein p and q are such numbers as to give Mn=5,800 and Me is methyl (Mn=5,800, Mw/Mn=1.21) was used instead of 100 parts of the hydroxyl end-capped polydimethylsiloxane having a viscosity of 20,000 mPa·s at 23° C.

Each of the silicone rubber compositions (Compositions 1 to 6) of Examples and Comparative Examples was cast into a frame of 2.5 mm high and cured at 23° C. and 50% RH for 7 days, forming a rubber sheet of 2 mm thick. The physical properties of the 2-mm rubber sheet were measured according to JIS K6249. Separately, each of Compositions 1 to 6 was cast into a frame of 1.3 mm high and cured at 23° C. and 50% RH for 7 days, forming a rubber sheet of 1 mm thick. The electrical properties of the rubber sheet were measured before and after immersion in water at 23° C. for 16 hours. Further, each of Compositions 1 to 6 was cast into a frame of 8 mm high and cured at 23° C. and 50% RH for 14 days, forming a rubber sheet of 6 mm thick. A tracking test was carried out on this sheet. The results are shown in Table 1.

Tracking Test

The test was according to the standard ASTM D-2303-64T. To a test assembly with an electrode-to-electrode distance of 50 mm under an applied voltage of 4 kV, a foul solution (an aqueous solution containing 0.1% of NH₄Cl and 0.02% of nonionic surfactant) was applied dropwise from the upper electrode at a rate of 0.6 ml/min. A time taken until a track was created to turn conductive was measured.

TABLE 1

| | | Example | | Comparative Example | | | |
|---|---|---|---|---|---|---|---|
| | | 1 | 2 | 1 | 2 | 3 | 4* |
| Physical | Viscosity, BH/No.5/2 rpm | 12 | 10 | 11 | 60 | 11 | UM |
| properties | (Pa · s) | | | | | | |
| | Viscosity, BH/No.5/20 rpm | 5 | 4 | 4 | 12 | 4 | UM |
| | (Pa · s) | | | | | | |
| | Thixotropy index | 2.4 | 2.5 | 2.8 | 5.0 | 2.8 | UM |
| | Hardness (Durometer A) | 53 | 50 | 52 | 55 | 50 | UM |
| | Elongation at break (%) | 170 | 200 | 150 | 120 | 100 | UM |
| | Tensile strength (MPa) | 2.0 | 1.9 | 1.8 | 2.2 | 1.8 | UM |
| Initial | Volume resistivity (Ωcm) | 3.0 × 10¹⁴ | 3.1× 10¹⁴ | 2.8 × 10¹⁴ | 3.0 × 10¹⁴ | 2.0 × 10¹⁴ | |
| electrical | Dielectric constant @50 Hz | 3.9 | 4.0 | 3.6 | 3.7 | 3.7 | UM |
| properties | Dielectric loss @50 Hz | 0.04 | 0.04 | 0.04 | 0.04 | 0.04 | UM |
| Electrical | Volume resistivity (Ωcm) | 8.5 × 10¹³ | 9.2 × 10¹³ | 5.2 × 10⁸ | 4.5 × 10⁸ | 1.1 × 10¹⁰ | |
| properties | Dielectric constant @50 Hz | 4.6 | 4.5 | UM | UM | 8.0 | UM |
| after | Dielectric loss @50 Hz | 0.4 | 0.6 | UM | UM | 1.0 | UM |
| water | | | | | | | |
| immersion | | | | | | | |
| Tracking | Tracking time (hr) | >6 | >6 | 2 | 2 | 3 | UM |
| test | | | | | | | |

UM: unmeasurable
*Note that in Comparative Example 4, the viscosity of this composition was unmeasurable in the sense that it was beyond the upper limit of measurement when measured under the described conditions, and no cured sheets of 1, 2 or 6 mm thick were obtained under the described curing conditions.

There has been described a silicone rubber coating composition which is coated onto the surface of insulator bodies of porcelain or glass (serving as post insulators or the like) to form a high-voltage electric insulator film thereon. It maintains the stabilized electrical properties of silicone rubber over a long period of time even in the ambient environment that is exposed to rain and weather.

Japanese Patent Application No. 2003-194280 is incorporated herein by reference.

While preferred embodiments have been shown and described, various modifications and substitutions may be made thereto without departing from the spirit and scope of the invention. Accordingly, it is to be understood that the present invention has been described by way of illustrations and not limitation.

1. A silicone rubber coating composition for use as a high-voltage electric insulator, comprising
(A) 100 parts by weight of an organopolysiloxane having the general formula (1):
HO(SiR₂O)ₙH (1)
wherein R is each independently a substituted or unsubstituted monovalent hydrocarbon group having 1 to 10 carbon atoms, and n is an integer of at least 10, or an organopolysiloxane having the general formula (2): 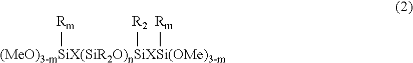
wherein R and n are as defined above, Me is methyl, X is an oxygen atom or an alkylene group having 2 to 5 carbon atoms, and m is each independently 0 or 1, or both,
(B) 0.1 to 50 parts by weight of an organosilicon compound having at least three hydrolyzable groups each attached to a silicon atom in a molecule or a partial hydrolyzate thereof, and
(C) 20 to 400 parts by weight of aluminum hydroxide which has been surface treated with a silane, siloxane or silazane.

2. The composition of claim 1, wherein the amount of carbon deposited on aluminum hydroxide is 0.01 to 2% by weight based on the aluminum hydroxide.

3. The composition of claim 1, wherein the aluminum hydroxide (C) has a mean particle size of 6 to 30 μm.

4. The composition of claim 1, wherein the surface-treated aluminum hydroxide (C) is obtained by the reaction of aluminum hydroxide with an alkylalkoxysilane or a partial hydrolyzate thereof.

5. The composition of claim 4 wherein the alkylalkoxysilane is an ethylalkoxysilane.

6. The composition of claim 1, further comprising (D) a solvent.
